(19) United States
(12) Patent Application Publication
(10) Pub. No.: US 2006/0080413 A1
(43) Pub. Date: Apr. 13, 2006

(54) Method and system for establishing a deployment plan for an application

(75) Inventors: Andrei Oprea, Toronto (CA); Razvan C. Peteanu, North York (CA)

Correspondence Address: Jeffrey S. LaBaw;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/870,227

(22) Filed: Jun. 17, 2004

(51) Int. Cl. G06F 15/177

(52) U.S. Cl. 709/220

(57) ABSTRACT

A method and system for establishing a deployment plan for an application. The deployment plan represents the dependencies between the application's elements and the physical and networking components of a deployment and provides a framework for the steps to be taken in order to realize the application deployment within a system for managing the deployment of the application. The deployment plan can be established using as input a user provided logical application structure for an application to be deployed and a chosen application deployment template comprising a logical deployment template and a network topology template.

### CROSS-REFERENCE TO RELATED APPLICATIONS

United States Patent applications entitled “Method and System for Managing Application Deployment” and “Method and System for Establishing a Server Template for an Application” were filed concurrently herewith.

### FIELD OF INVENTION

The present invention relates to the field of application deployment management. In particular, to a system and a method for establishing a deployment plan for an application.

### BACKGROUND

Deployment of applications in environments, such as a data centre or a testing environment, involves a complex setup process which is often done manually for each separate deployment. The deployment setup can involve a combination of both common components that are specific to the application but are not dependent on the environment and components that are specific to the environment. When an application is deployed in different environments using the manual process, the deployment setup is manually recreated for each new environment even if there are components that are common for every deployment of the application. This redundancy in the specification of the common components for the application is cumbersome and can introduce errors and inconsistencies between different but similar deployments.

Further, since the deployment setup is a manual process, the requirements of the application are conceptualized by a use employing actual resources available in the data center. Preservation of such a logical view of the deployment would enable flexibility in the assignment of resources for the deployment of the application.

### SUMMARY OF INVENTION

A method and system for establishing a deployment plan for an application. The deployment plan represents the dependencies between the application's elements and the physical and networking components of a deployment and provides a framework for the steps to be taken in order to realize the application deployment within a system for managing the deployment of the application. The deployment plan can be established using as input a user provided logical application structure for an application to be deployed and a chosen application deployment template comprising a logical deployment template and a network topology template.

In accordance with one aspect of the present invention, a system for establishing a deployment plan comprising logical configuration requirements for the deployment of an application, the system receiving a logical application structure defining logical elements of the application, a logical deployment template defining nodes for supporting deployment of the logical elements and a network topology template defining configuration elements for resolving dependencies between the nodes, the system comprising: an application mapping mechanism for mapping the logical elements identified in the logical application structure onto the nodes defined in the logical deployment template; a pool identification mechanism for identifying hardware resources associated with a node that have the same configuration requirements to form a pool; a logical deployment mechanism for generating a logical deployment that captures configuration requirements for each of the nodes including a network connection configuration; a networking requirements mechanism for resolving the network connection configuration requirements in the logical deployment using the network topology template; a plan mechanism for generating the deployment plan comprising configuration requirements for each of the nodes and network connections between the nodes; and a server deployment mechanism for generating a server template that contains the configuration requirements for the hardware resources in a pool, the server template for the pool being included in the deployment plan.

In accordance with an aspect of the present invention there is provided method for establishing a deployment plan comprising logical configuration requirements for the deployment of an application comprising steps for: obtaining a logical application structure defining logical elements of the application, a logical deployment template defining nodes for supporting deployment of the logical elements and a network topology template defining configuration elements for resolving dependencies between the nodes; mapping the logical elements identified in the logical application structure onto the nodes defined in the logical deployment template; identifying hardware resources associated with a node that have the same configuration requirements and generating a server template that comprising the configuration requirements for the identified hardware resources; generating a logical deployment that captures the configuration requirements for each of the nodes including a network connection configuration; resolving the network connection configuration requirements in the logical deployment using the network topology template; and generating the deployment plan containing configuration requirements for each of the nodes and network connections between the nodes and the server template.

In accordance with an aspect of the present invention there is provided a computer program product for establishing a deployment plan comprising logical configuration requirements for the deployment of an application, the computer program product comprising: computer readable program code devices for: obtaining a logical application structure defining logical elements of the application, a logical deployment template defining nodes for supporting deployment of the logical elements and a network topology template defining configuration elements for resolving dependencies between the nodes; mapping the application elements identified in the logical application structure onto the nodes defined in the logical deployment template; identifying hardware resources associated with a node that have the same configuration requirements and generating a server template comprising the configuration requirements for the identified hardware resources; generating a logical deployment that captures the configuration requirements for each of the nodes including a network connection configuration; resolving the network connection configuration requirements in the logical deployment using the network topology template; and generating the deployment plan containing configuration requirements for each of the nodes and network connections between the nodes.

Other aspects and features of the present invention will become apparent to those ordinarily skilled in the art to which it pertains upon review of the following description of specific embodiments of the invention in conjunction with the accompanying figures.

### BRIEF DESCRIPTION OF DRAWINGS

The present invention will be described in conjunction with the drawings in which:

FIG. 1 illustrates a system for managing the deployment of an application;

FIG. 2 illustrates a method of establishing a deployment plan;

FIG. 3 illustrates a deployment mechanism of the system of FIG. 1; and

FIG. 4 is graphical representation of an exemplary deployment plan according to the present invention.

### DETAILED DESCRIPTION

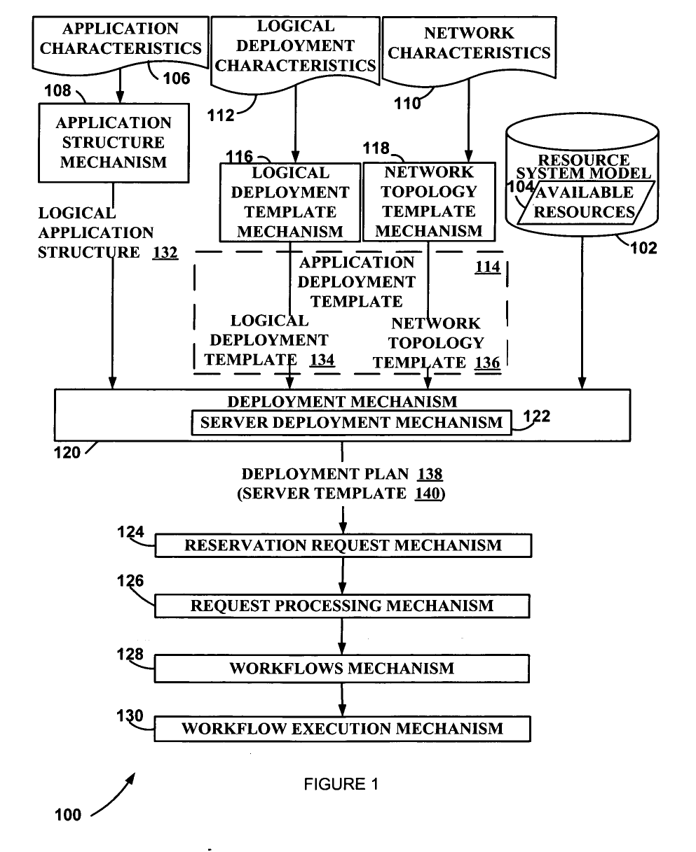

FIG. 1 illustrates a system 100 for managing the deployment of an application using resources in a resource system (not shown), such as a data center. The system 100 balances the availability of resources in the resource system and characteristics describing the desired configuration of these resources with resource requests from the application for execution thereof. An exemplary system 100 is described in detail in commonly owned co-pending application titled “Method and System for Managing Application Deployment”, filed concurrently herewith and incorporated herein by reference.

The resources in the resource system are represented in a resource system model 102 containing data on available resources 104. The available resources 104 may be any resource used for the execution of an application, including servers, routers, software licenses, etc., which has available capacity. The data on the available resources 104 includes information on the characteristics and configurability of each resource in the resource system model 102 that is germane to the resource system. Such information can include total resource capacity, available capacity, speed, communication protocols, etc.

The resource system model 102 also represents the relationships between the available resources 104 where applicable, such as connections between servers, etc.

The application is considered to be composed of multiple elements which are the distinct deployable units. The application is broken down such that each element contains a small amount of application functionality but still retains its distinct deployability. Each element has a known type that is used for processing the deployment of the application.

The application structure mechanism 108 receives application characteristics 106 and produces a logical application structure 132 therefrom for use by other mechanisms in the system 100. The application characteristics 106 represent resources and their configurations that may be used for deployment of the application. The logical application structure 132 contains a characterization of resource dependencies for each element. The application may be successfully deployed when these resource dependencies are satisfied.

Logical deployment characteristics 112 and network characteristics 110 are received by a logical deployment template mechanism 116 and a network topology template mechanism 118, respectively. The logical deployment characteristics 112 are specified by a user to provide a logical view of the desired characteristics of the configuration of a desired deployment. The networking characteristics 110 are specified by a user to depict communication connections between resources. The network characteristics 110 and the logical deployment characteristics 112 are used by the mechanisms 116 and 118 to form an application deployment template 114 that sets out the desired characteristics of a deployment (not specific to the current application being deployed) in a manner that can be used in determining deployment of resources.

The logical deployment template mechanism 116 receives the logical deployment characteristics 112 and produces a logical deployment template 134. The logical deployment template 134 describes from a logical view how different types of elements that could compose the application are to be deployed according to various types of resources. The logical deployment template 134 contains a logical characterization of a desired deployment. The network topology template mechanism 118 receives the network characteristics 110 and forms a network topology template 136. The network topology template 134 describes the network connections for different types of elements that could be in the application. The network topology template 136 contains a network configuration of the desired deployment. The logical deployment template 134 and the network topology template 136 together form the application deployment template 114.

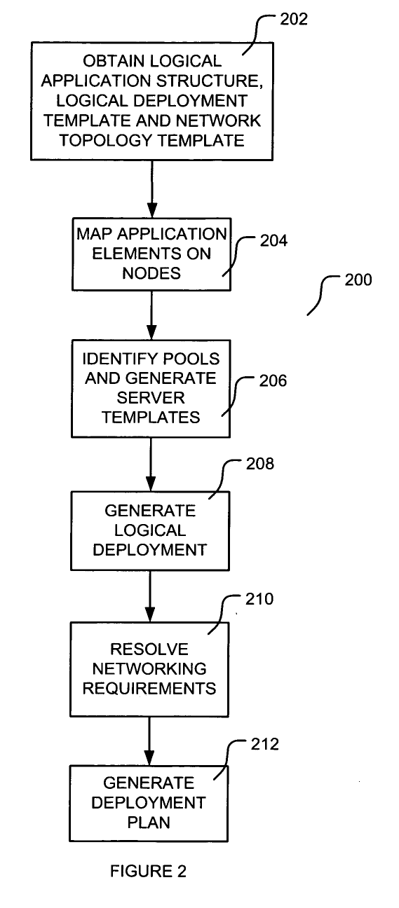

A deployment mechanism 120 receives the logical deployment template 134, the network topology template 136 and the logical application structure 132 to develop a deployment plan 138 which contains the target software and hardware configurations to be implemented for the deployment of the application. The deployment plan 138 presents a logical view of the deployment configuration showing functional components which may actually consist of multiple hardware and/or software resources having a particular configuration and performing a specific function. The networking configuration and the hardware to support this configuration for the deployment are outlined in the deployment plan 138 along with the dependencies between elements that are depicted in the logical application structure 132. The deployment plan 138 provides a high level deployment solution for the application given the logical application structure 132 in the environment described in the network topology template 136 and the logical deployment template 134. The deployment mechanism 120 will be discussed later in conjunction with FIGS. 2-4.

Within the deployment plan 138, servers may be treated as separate resources or multiple servers may be grouped together to form a cluster. Each server in a cluster (or each of some other resource in a cluster) can have the same configuration. The deployment mechanism 120 contains a server deployment mechanism 122 that produces a server template 140 containing configurations for server clusters for the deployment. An exemplary server deployment mechanism 122 is described in detail in commonly owned co-pending application titled “Method and System for Establishing a Server Template for an Application,” filed concurrently herewith and incorporated herein by reference.

The deployment plan 138 with the server template 140 are provided to a reservation mechanism 124 which forms a request for the resources identified in the deployment plan 138. This request is provided to request processing mechanism 126 of the system where the resources request is reviewed.

The request processing mechanism 126 coordinates all requests for resources in the resource system with the available resources 104. While the deployment plan 138 provides a logical conceptual view of the deployment solution, the request processing mechanism 126 translates that conceptual view into a more physical actual depiction of the deployment including specifying individual resources that are to be assigned in the deployment and the configuration of those resources.

The resources that are to be deployed and the configuration that these resources are to be given is communicated to a workflows mechanism 128 so that a workflow to deploy these resources can be created. The workflow to deploy the application is provided to a workflow execution mechanism 130 for implementation.

FIG. 2 illustrates a method 200 of establishing a deployment plan. The deployment plan contains information pertaining to the deployment of the application from a hardware and networking context, outlining dependencies between application elements and networking configurations to support these dependencies. The deployment plan provides a top-down view of a deployment, starting from the software components and the relationships between them, going through a logical structure of the deployment, networking configuration elements and hardware infrastructure (e.g. nodes) that will be used to realize the deployment. The method 200 may be implemented in the deployment mechanism 120 shown in FIG. 1.

In step 202 a logical application structure 132, a logical deployment template 134 and a network topology template 136 are obtained. The logical application structure 132 identifies the application elements, including their types, of the application to be deployed.

The logical deployment template 134 and the network topology template 136 may be selected from among templates in a data store. Selection of the templates 134 and 136 may be based on the type of elements in the logical application structure 132, various requirements for the elements, etc. For example, the templates 134 and 136 selected may be those templates that specify desired configuration characteristics for every type of element in the logical application structure 134.

Step 204 is the mapping of the application elements identified in the logical application structure 132 onto the nodes contained in the logical deployment template 134. This mapping is achieved by matching the types of the application elements with the element types hosted by the nodes. The mapping of the application elements onto the nodes permits the configuration requirements associated with each of the application elements to be generated. The logical application structure 132 specifies resources requirements, associated with each node type, such as, for example, the hardware requirements (e.g. processor and memory specifications), the software requirements (e.g. the software stack from the application layer to the operating system layer) and the network requirement (e.g. logical connections) that must be provided by a node to which an application element is assigned.

Clusters of hardware resources may form each node. One or more of the hardware resources in a cluster can have the same configuration requirements. Where more than one hardware resource has the same configuration requirements, the resources form a pool. In step 206 pools are identified and server templates 140 are generated. A server template 140 can be used to represent the configuration requirements for each of the hardware resources in a pool. The server deployment mechanism 122 can generate a server template 140 for each identified pool.

In step 208 a logical deployment is generated that captures the configuration requirements for each of the logical nodes assigned to an application element, the logical connections (i.e. dependencies) between the logical nodes and the configuration requirements for each of the nodes including server templates 140 for any identified pools.

In step 210, the network related configuration requirements are elaborated by resolving the networking requirements expressed in the logical deployment using the network topology template 136. The logical connections of the logical deployment are elaborated into configurations requirements including, for example, identification and specification of virtual local area networks (VLAN), identification and specification of sub networks (subnets), node connections to the VLAN and subnets, network interface card (NIC) requirements, network port assignments, internet protocol (IP) address assignments, firewall requirements and router assignments and requirements. The specified resources may be sharable resources. Specified resources can be logical resources based on type and specification with actual assignment to a specific datacenter resource deferred to a later phase of the application deployment.

The configuration requirements for each of the logical nodes assigned to an application element including server templates 140 for any identified pools and the network connections between the logical nodes are combined to form the deployment plan in step 212. The deployment plan 138 can be stored as, for example, an XML structure that can be used for both visualization and editing, and for the deployment process. The deployment plan 138 can contain one or more server templates 140 each pertaining to the servers in a pool or cluster. In an alternative embodiment, the deployment plan 138 can be established using another tool that can generate a structure representing the connections between the different layers of an application deployment.

Since the deployment plan does not necessarily contain a complete mapping of the logical application structure to the available resources (i.e. there are some resources that are only generally indicated in the deployment plan), the deployment plan provides a view of the deployment that is decoupled from the actual resources that are used for the deployment. As a result, the deployment plan may be used for subsequent deployments or reassignments of resources without being developed repeatedly for each change.

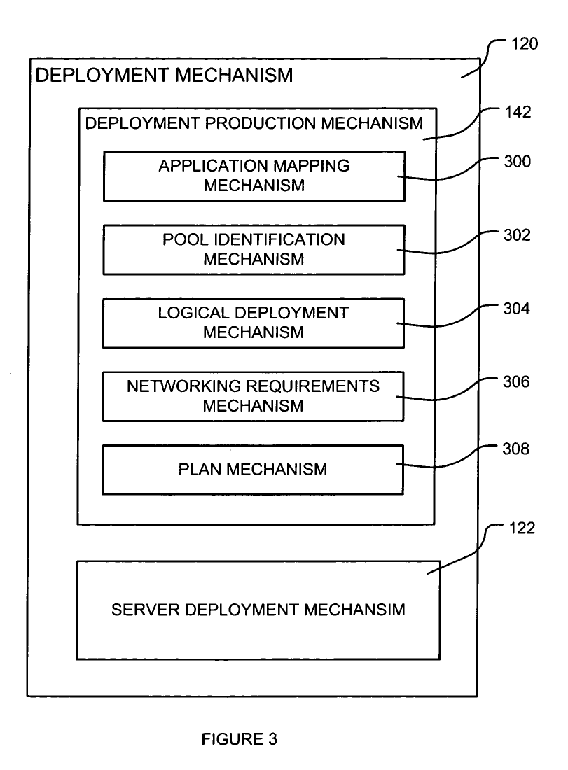

FIG. 3 shows the deployment mechanism 120 of FIG. 1. The deployment mechanism 120 comprises the deployment plan production mechanism 142 and the server deployment mechanism 122. The server deployment mechanism 122 develops the server templates that each contains the configuration for the hardware resources in a pool.

The deployment plan production mechanism 142 includes an application mapping mechanism 300, a pool identification mechanism 302, a logical deployment mechanism 304, a networking requirements mechanism 306 and a plan mechanism 308. The application analysis mechanism 300 maps the application elements identified in the logical application structure 132 onto the nodes contained in the logical deployment template 134. This mapping is achieved by matching the types of the application elements with the element types hosted by the nodes. The pool identification mechanism 302 identifies one or more of the hardware resource in a cluster that have the same configuration requirements. The server deployment mechanism 122 develops the server templates that each contains the configuration for the hardware resources in a pool. The logical deployment mechanism 304 generates a logical deployment that captures the configuration requirements for each of the logical nodes assigned to an application element, the logical connections (i.e. dependencies) between the logical nodes and the configuration requirements for each of the nodes including server templates 140 for any identified pools. The networking requirements mechanism 306 elaborates the network related configuration requirements by resolving the networking requirements expressed in the logical deployment using the network topology template 136. The plan mechanism 308 forms the deployment plan containing configuration requirements for each of the logical nodes assigned to an application element including server templates 140 for any identified pools and the network connections between the logical nodes.

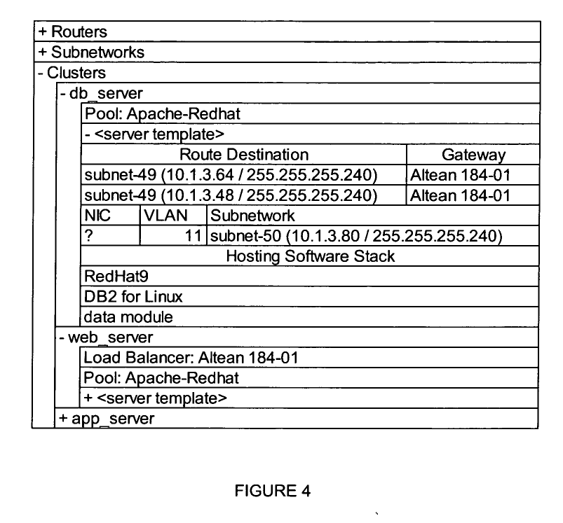

FIG. 4 is graphical representation of an exemplary deployment plan according to the present invention. The deployment plan 138 is hierarchically organized. Top level sections are illustrated related to routers, subnetworks and clusters. The clusters section is expanded to show clusters related to a database server (db_server), a web server (web_server) and an application server (app_server). The database server cluster (db_server) is expanded to show a pool association and an associated server template 140. The server template 140 contains sections related to configuration information for route destinations, gateways, subnetworks, network interface cards (NIC), virtual local area networks (VLAN) and hosting software stacks.

The specific entities and entity types contained in the deployment plan 138 shown in FIG. 4 are illustrative. Other similar entities and entity types can be included in the deployment plan 138 while remaining within the spirit and scope of the present invention.

Embodiments of the present invention may be implemented in any conventional computer programming language. For example, embodiments may be implemented in a procedural programming language (e.g. “C”) or an object oriented language (e.g. “C++”). Further embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g. a diskette, CD-ROM, ROM, or fixed disk) or transmittable to a computer system, via a modem or other interface device, such as a communications adapter connected to a network over a medium. The medium may be either a tangible medium (e.g. optical or electrical communications lines) or a medium implemented with wireless techniques (e.g. microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g. shrink wrapped software), preloaded with a computer system (e.g., on system ROM or fixed disk), or distributed from a server over the network (e.g., the Internet or World Wide Web). Some embodiments of the invention may be implemented as a combination of both software (e.g. a computer program product) and hardware (termed mechanisms). Still other embodiments of the invention may be implemented as entirely hardware, or entirely software (e.g. a computer program product).

It will be apparent to one skilled in the art that numerous modifications and departures from the specific embodiments described herein may be made without departing from the spirit and scope of the present invention.

1. A system for establishing a deployment plan comprising logical configuration requirements for the deployment of an application, the system receiving a logical application structure defining logical elements of the application, a logical deployment template defining nodes for supporting deployment of the logical elements and a network topology template defining configuration elements for resolving dependencies between the nodes, the system comprising:
an application mapping mechanism for mapping the logical elements identified in the logical application structure onto the nodes defined in the logical deployment template;
a pool identification mechanism for identifying hardware resources associated with a node that have the same configuration requirements to form a pool;
a logical deployment mechanism for generating a logical deployment that captures configuration requirements for each of the nodes including a network connection configuration;
a networking requirements mechanism for resolving the network connection configuration requirements in the logical deployment using the network topology template;
a plan mechanism for generating the deployment plan comprising configuration requirements for each of the nodes and network connections between the nodes; and
a server deployment mechanism for generating a server template that contains the configuration requirements for the hardware resources in a pool, the server template for the pool being included in the deployment plan.

2. The system of claim 1, said deployment plan comprising:
an identification of software components;
a logical structure associating said software components with said nodes; and
configuration elements.

3. The system of claim 1, wherein said deployment plan is an extensible markup language (XML) structure.

4. The system of claim 1, wherein said logical application structure is specific to the application.

5. The system of claim 1, wherein said logical deployment template is derived from a logical deployment characteristic set that is non-application specific.

6. The system of claim 1, wherein said network topology template is derived from a network characteristic set that is non-application specific.

7. A method for establishing a deployment plan comprising logical configuration requirements for the deployment of an application comprising steps for:
a) obtaining a logical application structure defining logical elements of the application, a logical deployment template defining nodes for supporting deployment of the logical elements and a network topology template defining configuration elements for resolving dependencies between the nodes;
b) mapping the logical elements identified in the logical application structure onto the nodes defined in the logical deployment template;
c) identifying hardware resources associated with a node that have the same configuration requirements and generating a server template that comprising the configuration requirements for the identified hardware resources;
d) generating a logical deployment that captures the configuration requirements for each of the nodes including a network connection configuration;
e) resolving the network connection configuration requirements in the logical deployment using the network topology template; and
f) generating the deployment plan containing configuration requirements for each of the nodes and network connections between the nodes and the server template.

8. The method of claim 7, said deployment plan comprising:
an identification of software components;
a logical structure associating said software components with said nodes; and
configuration elements.

9. The method of claim 7, wherein said deployment plan is an extensible markup language (XML) structure.

10. The method of claim 7, wherein said logical application structure is specific to the application.

11. The method of claim 7, wherein said logical deployment template is derived from a logical deployment characteristic set that is non-application specific.

12. The method of claim 7, wherein said network topology template is derived from a network characteristic set that is non-application specific.

13. A computer program product for establishing a deployment plan comprising logical configuration requirements for the deployment of an application, the computer program product comprising:
computer readable program code devices for:
a) obtaining a logical application structure defining logical elements of the application, a logical deployment template defining nodes for supporting deployment of the logical elements and a network topology template defining configuration elements for resolving dependencies between the nodes;
b) mapping the application elements identified in the logical application structure onto the nodes defined in the logical deployment template;
c) identifying hardware resources associated with a node that have the same configuration requirements and generating a server template comprising the configuration requirements for the identified hardware resources;
d) generating a logical deployment that captures the configuration requirements for each of the nodes including a network connection configuration;
e) resolving the network connection configuration requirements in the logical deployment using the network topology template; and
f) generating the deployment plan containing configuration requirements for each of the nodes and network connections between the nodes.

14. The computer program product of claim 13, said deployment plan comprising:
an identification of software components;
a logical structure associating said software components with said nodes; and
configuration elements.

15. The computer program product of claim 13, wherein said deployment plan is an extensible markup language (XML) structure.

16. The computer program product of claim 13, wherein said logical application structure is specific to the application.

17. The computer program product of claim 13, wherein said logical deployment template is derived from a logical deployment characteristic set that is non-application specific.

18. The computer program product of claim 13, wherein said network topology template is derived from a network characteristic set that is non-application specific.
